(19) United States
(12) Patent Application Publication
(10) Pub. No.: US 2021/0256076 A1
(43) Pub. Date: Aug. 19, 2021

(54) INTEGRATED BROWSER EXPERIENCE FOR LEARNING AND AUTOMATING TASKS

(71) Applicant: Microsoft Technology Licensing, LLC, Redmond, WA (US)

(72) Inventors: Steven Michael McMurray, Maple Valley, WA (US); Sophors Khut, Seattle, WA (US); Juan Gilberto Jose Marin Bear, Kirkland, WA (US); Guruansh Singh, Bellevue, WA (US); Yuxiao Sun, Redmond, WA (US)

(21) Appl. No.: 16/791,317

(22) Filed: Feb. 14, 2020

(51) Int. Cl. G06F 16/958; G06N 20/00; G06N 5/04

(52) U.S. Cl. CPC G06F 16/958; G06N 5/04; G06N 20/00

(57) ABSTRACT

In non-limiting examples of the present disclosure, systems, methods and devices for automating web browser task actions are presented. An indication to record a new action may be received. One or more steps associated with the action may be performed during the recording. Each step may comprise interaction with a different webpage element corresponding to an HTML node. The HTML node, and one or more additional HTML nodes may be extracted and/or tagged, and a machine learning model may be applied to the extracted/tagged nodes. The machine learning model may have been trained to create templates for identifying interacted-with web elements. The automated action may be performed by applying the machine learning model to one or more websites. The machine learning model may identify the correct web elements to interact with and move through the action steps in an automated manner to perform the action.

### BACKGROUND

Users frequently perform the same tasks over and over in a web browser. Examples of these tasks include: booking a table at a restaurant, purchasing items from a shopping website, buying movie tickets from a movie theater, etc. These task flows can include a long series of steps that are time consuming to input, despite the fact that many if not all of the inputs for the steps are the same for each instance that the task is repeated. Additionally, websites can change their layouts regularly, making it frustrating for users to complete tasks in a manner that they were previously used to.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for automating web browser task actions. Web browser task actions may comprise activities performed in a web browser such as flight booking, restaurant reservations, car booking, shopping, and ticket booking, for example. Users may wish to automate all or a portion of these activities to reduce the amount of time and effort required to execute a web browser task action that they perform regularly. Aspects of the disclosure provide mechanisms for accomplishing this.

An indication to record a new browser task action may be received by a task action service. In some examples, the task action service may be located all or in part on a local device. For example, the task action service may be incorporated as part of a browser application executed locally on a local computing device. In other examples, the task action service may be located all or in part in the cloud. For example, the task action service may be incorporated in a remote browser service or a remote stand-alone service. A plurality of web element interactions on a website may be received. Each interaction with a website element may correspond to a different step in a web browser task action being recorded. A machine learning model may be applied to each interacted-with web element. The machine learning model may have been trained to generate a definition for web elements. In some examples, the machine learning model may comprise an instance-based learning model. In such instances, the machine learning model may extract and tag nodes corresponding to each interacted-with web element and one or more additional nodes. The machine learning model may generate templates that define the nodes corresponding to the interacted-with web elements. The templates and definitions for each interacted-with web element may be saved as part of a new web browser task action. When an indication is received to perform a saved web browser task action, the templates and definitions may be applied to a website to identify the correct web-elements to interact with and/or fill out.

### BRIEF DESCRIPTION OF THE DRAWINGS

Non-limiting and non-exhaustive examples are described with reference to the following figures:

FIG. 1 is a schematic diagram illustrating an example distributed computing environment 100 for automating web browser task actions.

FIG. 2 illustrates a computing environment for the customization of a web browser task action where an automated step is modified to a custom field.

FIG. 3 illustrates a schematic diagram illustrating an example distributed computing environment 300 for training and applying a machine learning model for automating web browser task actions.

FIG. 4 illustrates a schematic diagram illustrating an example distributed computing environment 400 for training and applying an instance-based machine learning model for automating web browser task actions.

FIG. 5A illustrates a computing environment for creating a new web browser task action across multiple pages of a website.

FIG. 5B illustrates the finalization of the new web browser task action created in

FIG. 5A.

FIG. 6 illustrates a computing environment for creating a new task action related to dynamic content and adding an option to be notified when the dynamic content meets a threshold value.

FIG. 7 is an exemplary method for automating web browser task actions.

FIG. 8 is another exemplary method for automating web browser task actions.

FIGS. 9 and 10 are simplified diagrams of a mobile computing device with which aspects of the disclosure may be practiced.

FIG. 11 is a block diagram illustrating example physical components of a computing device with which aspects of the disclosure may be practiced.

FIG. 12 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

Examples of the disclosure provide systems, methods, and devices for automating web browser task actions. Users may repeat a same series of steps and associated inputs to execute web browser task actions they execute frequently. The current disclosure provides mechanisms for automating those actions. An indication to record a new web browser task action may be received. The indication may be received by a task action service. In some examples, the task action service may be located all or in part on a local device. For example, the task action service may be incorporated as part of a browser application executed locally on a local computing device. In other examples, the task action service may be located all or in part in the cloud. For example, the task action service may be incorporated in a remote browser service or a remote stand-alone service. The indication to record a new web browser task action may be received via an explicit command received via a web browser application. In other examples, the indication to record a new web browser task action may be received via an explicit command received via an operating system shell element. In still other examples, the indication to record a new web browser task action may be received via a natural language input (e.g., a voice command to a digital assistant, a text command to a digital assistant).

Once the indication to record a new browser task action is received the task action service may begin the recording process. During the recording process, the task action service tracks inputs associated with web elements on active webpages. The web elements may correspond to text input fields, drop down lists, calendar selection menus, and other menu selection elements (e.g., time selection elements, place selection elements, size selection elements, etc.). The task action service may track each of these inputs until an indication to stop recording is received.

The tracking of the inputs on the web elements may comprise extracting each interacted-with node corresponding to an interacted-with web element. For example, the task action service may analyze the HTML code associated with an open webpage, determine that a user has interacted with a particular web element (e.g., clicked on a menu item, input text into a text input field element), and the task action service may extract the DOM node corresponding to that particular web element. In some examples, the entire webpage may be extracted and the node corresponding to the interaction may be tagged. The task action service may extract and/or tag one or more additional nodes from the webpage in addition to the node where the interaction was received. The one or more additional nodes may be nodes that are proximate to the node that was interacted with. For example, the first X number of nodes above the interacted-with node in the HTML code, and the first Y number of nodes below the interacted-with node in the HTML code, may be extracted from the webpage. In other examples, the additional nodes need not be directly above or directly below the node corresponding to the interaction.

A machine learning model that has been trained to identify web elements based on node features may be applied to the extracted/tagged nodes. In some examples, the machine learning model may comprise an instance-based learning model. The task action service, in association with the machine learning model, may determine one or more features associated with the primary node that was extracted (e.g., the node corresponding to the interacted-with web element) and one or more features associated with the one or more secondary nodes that were extracted (e.g., the nodes surrounding the primary node), and generate a template that may be utilized to identify the specific node/web element during task action run time.

Between the time that a task action was recorded and when it is run, one or more corresponding webpages may have been changed, the classification of the nodes may have been incorrect to begin with, or the classification of the nodes may not exist in the HTML. Thus, in applying an instance-based learning model and generating templates that may be applied to a webpage regardless of changes to the code and/or classifications, the task action service is capable of identifying the appropriate nodes/web elements to interact with for each step of a recorded action. If the instance-based learning model selects a wrong node for one of the steps, user feedback can be provided to the task action service to train the model such that it becomes more and more accurate over time.

The extraction of primary and secondary nodes is performed for each step of a web browser task action recording process. Additionally, any information that is input into a dynamic field (e.g., a text entry field, a date selection field, a time selection field, a place selection field) may be saved along with the node information, and automatically applied to that node when identified during performance of the subsequent action. If a user would like to have a specific step in a task action be a modifiable step each time the automated task action is performed, that preference may be specified during task action recording and/or a previously recorded task action may be edited to incorporate that preference. For example, if step three of a recorded task action is input of May 22 into a date field web element, the task action may be edited so that each time the task action is performed, the user can modify that date field (e.g., select/input any date). Similarly, if step two of a recorded task action is input of SEA in an airport input field web element, the task action may be edited so that each time the task action is performed, the user can modify that airport field (e.g., select/input any airport code). In other examples, the user may modify one or more input fields for a recorded task action on the fly (e.g., determine at runtime which inputs/fields to modify).

Although the machine learning model applied to identify interacted-with web elements may be an instance-based learning model, other machine learning models may be utilized. For example, while the instance-based learning model may be more appropriate for use on local devices given their limited processing capabilities, neural networks and embedding models with large dictionary requirements may identify web elements (e.g., input fields, menu selection elements) to a significantly similar, or even higher, accuracy as instance-based learning models. However, neural networks and embedding models have significantly higher processing costs. As such, for privacy reasons, it may be preferred to perform lighter weight operations associated with instance-based learning models on local devices as opposed to performing more processing-intensive models in the cloud. Additionally, while most of the current description relates to extraction of HTML code and DOM nodes in the processing performed by machine learning models, other models may be applied to record application actions other than web browser applications. For example, an image-based neural network may be applied to identify interacted-with application elements from a productivity application such as a word processing application, to-do list application, and the like. In some examples, where task actions may encompass a web browser and a different application (e.g., a to-do list application, an email application), two or more machine learning models may be utilized. For example, an instance-based learning model may be applied to create templates for interacted-with web elements from a web browser, and a neural network may be applied to identify interacted-with application elements from a to-do list application or email application.

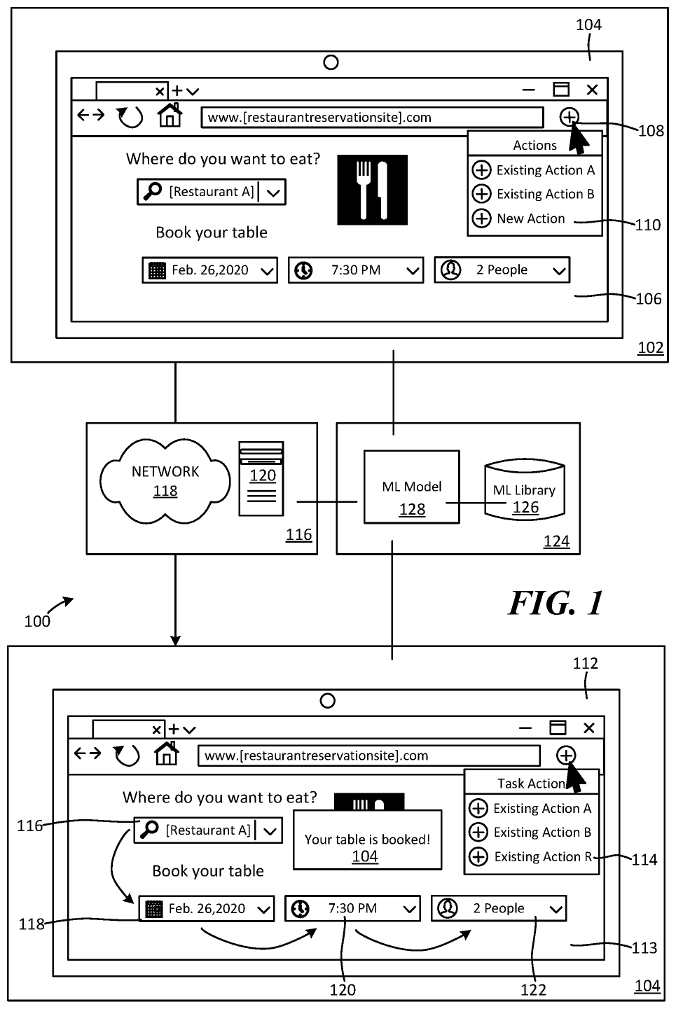

FIG. 1 is a schematic diagram illustrating an example distributed computing environment 100 for automating web browser task actions. Computing environment 100 includes new browser task action sub-environment 102, finalized new browser task action sub-environment 104, network and processing sub-environment 116, and machine learning sub-environment 124. Any and all of the computing devices described herein may communicate with one another via a network such as network 118.

New browser task action sub-environment 102 includes computing device 104, which may be the same computing device as computing device 112 in finalized new browser task action sub-environment 104. Computing device 104 displays web browser 106 (e.g., a web browser application). Web browser 106 is currently navigated to www.[restaurantreservactionsite].com. A user account may be associated with one or both of computing device 104 and/or web browser 106. Some or all data associated with the user account may be stored locally on computing device 104 and/or in the cloud (e.g., on one or more server computing devices such as server computing device 120). The user account may be associated with a task action service. Data and performance of operations associated with the task action service may be stored/performed locally (e.g., on computing device 104) and/or in the cloud (e.g., on one or more server computing devices such as server computing device 120). The task action service may save the identity of task actions associated with user accounts, task action steps, task action preferences, auto-complete data for use in task actions, and machine learning data for task actions. The task action service may utilize that data to perform task actions when specifically requested to (e.g., via manual input—such as user task action user interface selection, via digital assistant request) and/or automatically (e.g., periodically based on a set of rules, based on user-defined criteria).

In this example, a selection of new task action element 108 is received via web browser 106. Upon selection of new task action element 108, actions window 110 is caused to be surfaced. Actions window 110 includes existing actions associated with the user account, as well as a user interface element for adding/creating a new web browser task action. That is, actions window 110 includes first element “Existing Action A”, second element “Existing Action B”, and third element “New Action”. A selection of the “New Action” element is made, and a new browser task action may then be recorded.

Once recording of the new web browser task action is started, a user may simply perform the steps she would like recorded in the order she would like them performed by the automated process. In this example, the user would like to record an action for automatically booking a table via the restaurant reservation website. Thus, a first selection is made of restaurant identity element 116, where the user fills that field in with “[Restaurant A]”; a second selection is made of date element 118, where a drop-down menu is utilized to insert the date “Feb. 26, 2020”; a third selection is made of time element 120, where a drop-down menu is utilized to insert the time 7:30 PM; and a fourth selection is made of party number element 122, where a drop-down menu is utilized to insert the number of people for the reservation (2).

Once the desired steps for the web browser task action have been completed, a selection may be received to end recording of the action, and it may be saved as a new web browser task action. This selection is not shown in relation to FIG. 1. However, the selection has been made, and therefore new browser task action “Existing Action R” 114 is added to the actions associated with the user account (and to the actions window). Additionally, a table was actually booked during recording of the action, notification window 123 is caused to be surfaced, which states “Your table is booked!”.

A plurality of operations associated with machine learning sub-environment 124 may be performed in the recording of a new web browser task action, such as “Existing Action R” 114, as well as the automated performance of existing web browser task actions. Data and/or operations associated with machine learning sub-environment 124 may be stored/performed locally (e.g., on computing device 104, on computing device 112) and/or in the cloud (e.g., on one or more server computing devices, such as server computing device 120). For example, some or all data and machine learning model operations associated with the task action service may be performed locally. In other examples, only data and machine learning models associated with “private” information (e.g., banking actions, health record actions, etc.) may be stored/performed locally, while data associated with other actions may be stored/performed in the cloud. In still other examples, users may specify via settings and/or on a per-action basis, which action data and association machine learning model operations should be performed locally, and which action data and associated machine learning model operations should be performed in the cloud.

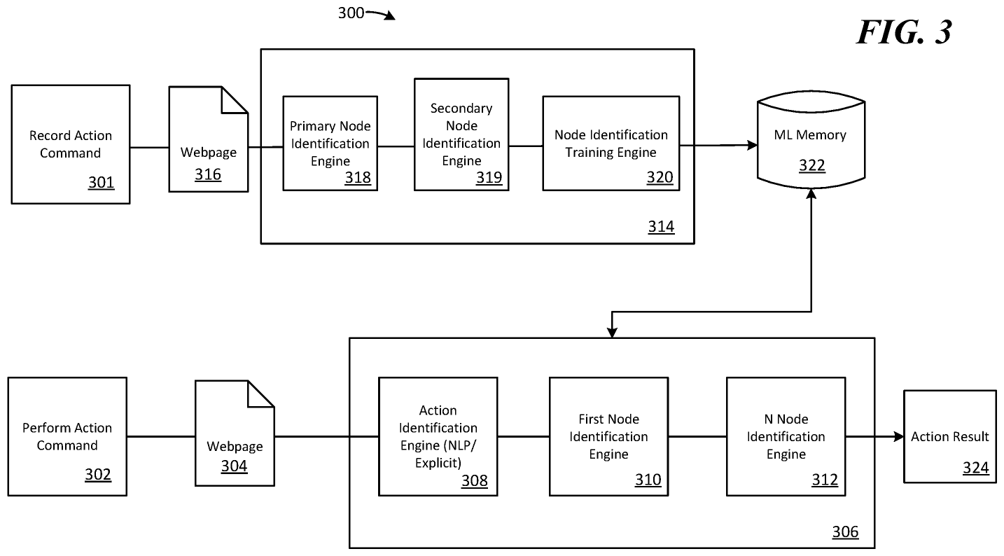

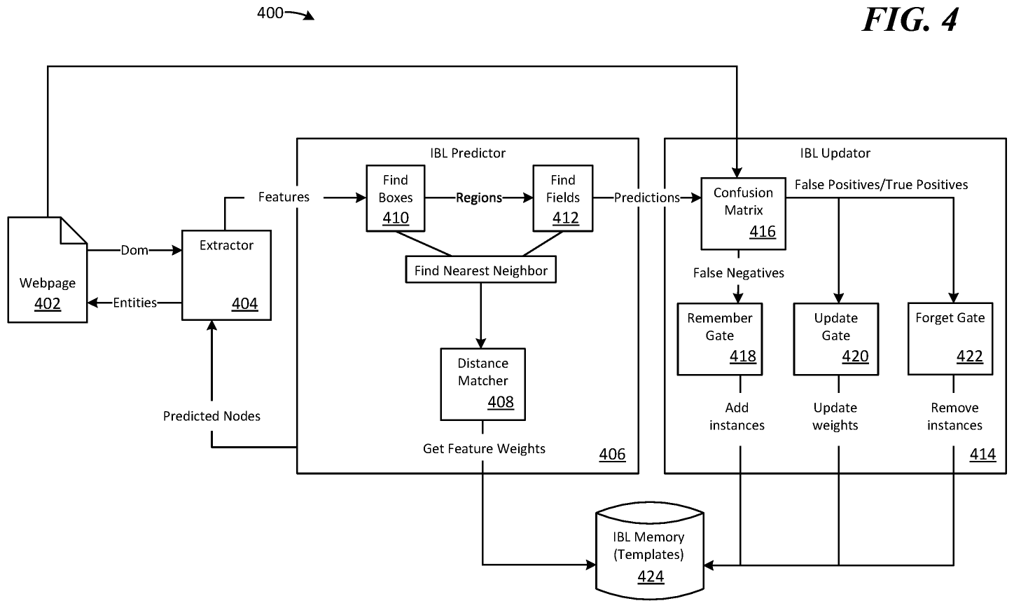

Machine learning sub-environment 124 includes machine learning model 128, which may include one or more machine learning models. Machine learning sub-environment 124 also includes machine learning library 126. The machine learning models included in machine learning model 128 may be applied to web browser data to identify web elements (e.g., restaurant identity element 116, date element 118, time element 120, party number element 122) associated with a task action and data input into those web elements. Machine learning library 126 may include stored web browser task actions, training data associated with web browser task actions, and/or data associated with one or more user accounts for which there are stored web browser task actions. Additional details regarding the machine learning models, and training thereof, is provided in relation to FIG. 3 and FIG. 4.

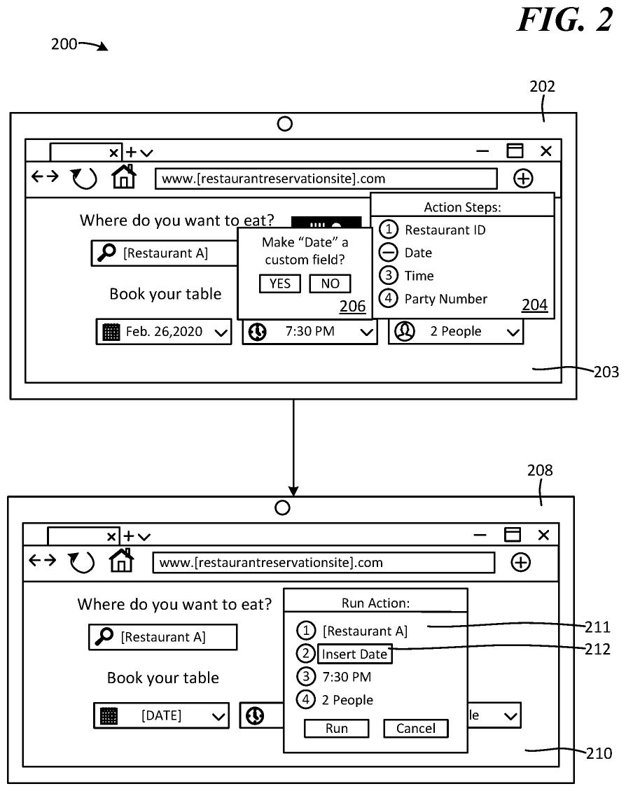

FIG. 2 illustrates a computing environment 200 for the customization of a web browser task action where an automated step is modified to a custom field. Computing environment 200 includes computing device 202 and computing device 208, which may be the same computing device as computing device 202. Web browser 203 is displayed on computing device 202. Action steps window 204 is displayed over web browser 203. Action steps window 204 includes steps for performing the web browser task action that was created in FIG. 1. Specifically action steps window 204 includes a first step that automatically fills in the restaurant ID based on the recording of the action, a second step that automatically fills in the date for the reservation based on the recording of the action, a third step that automatically fills in the time for the reservation, and a fourth step that automatically fills in the party number for the reservation.

Users may not always want to insert/select data in the action steps during performance of a saved task action that is exactly what they inserted/selected while they were recording the task action. For example, users may wish to change the restaurant, the date, the time, or the party number dynamically when then are performing an action. In some examples, a user that creates an action may determine that most of the steps for an action are going to be static most of the time, but that one or two steps are likely to be different each time an action is performed. Thus, in this example, a user has determined that the date that was recorded during the web browser task action should be a dynamic field that is manually filled in each time that the action is performed. As such, the user has made a selection of the second step, “Date”, and pop-out window 206 is caused to be displayed, which states: “Make ‘Date’ a custom field?”—with options for selecting “Yes” or “No”. In this example, the user selects the “Yes” option to make the date step a custom field.

As displayed on computing device 208, when a selection is made to open the reservation action, web browser 210 causes run action window 211 to be displayed. Run action window 211 displays the four steps that will be automatically performed in performing the action. However, insert date action 212 is now a dynamic field that must be filled out with a specific date prior to completion of the action. As such, the user may insert a custom date for the restaurant reservation. Once filled in, the restaurant reservation action may be completed automatically for that date.

FIG. 3 illustrates a schematic diagram illustrating an example distributed computing environment 300 for training and applying a machine learning model for automating web browser task actions. Computing environment 300 generically encompasses the training and performance of a machine learning model for identifying browser task action web elements (e.g., user interface element selections that are made during performance of a task action, text input fields that are utilized during performance of a task action, drop down menus that are utilized during performance of a task action, etc.).

Record action command 301 is received. The record action command is received in association with webpage 316. Once record action command 301 is received, the full webpage that is currently open on a web browser associated with the command may be provided to recording/training environment 314. Recording/training environment 314 includes primary node identification engine 318, secondary node identification engine 319, and node identification training engine 320. Although computing environment 300 describes multiple “node” engines, it may encompass web element processing engines rather than those node engines. For example, while primary node identification engine 318 relates to identifying an HTML node based on analysis of HTML code, a different type of machine learning model (e.g., an image-based neural network) may analyze webpage 316 and perform operations that result in substantially the same results (e.g., identification of a web element associated with a web browser action).

Primary node identification engine 318 may receive interaction notifications associated with one or more web elements. For example, once record action command 301 is received, a user may interact with a first web element (e.g., an input field) on webpage 316, and primary node identification engine 318 may receive notice of that interaction. In the case where the machine learning model analyzes HTML code, primary node identification engine 318 may tag the interacted with node corresponding to the interaction. In additional examples, where the machine learning model analyzes HTML code, secondary node identification engine 319 may identify a plurality of additional nodes that are also included in webpage 316, and tag those additional nodes along with the interacted-with node. Node identification training engine 320 may perform one or more instance-based learning model training operations on the primary node that was tagged by primary node identification engine 318 and one or more secondary nodes that were tagged by secondary node identification engine 319. Node identification training engine 320 may store data associated with the secondary nodes and the primary node as a set of features for the primary node as prototypes and build a classification model by similarity comparison. This instance-based approach has the advantage of not encoding the unit of analysis (i.e., no need to load big embedding/dictionary at runtime) and instead only requires a measure of distance between different units. Additional details and features related to the instance-based learning approach are provided in relation to FIG. 4.

In examples where an image-based neural network is utilized rather than the instance-based learning model, an image may be extracted corresponding to a node where a web element interaction is received. That image may be provided to a neural network that has been trained to classify images based on type. In some examples, the image corresponding to the interacted-with web element and images for one or more surrounding web elements may be extracted and passed to a neural network that has been trained to classify images based on type.

This process of node feature prototype building in the case of the instance-based learning model and/or the image classification in the neural network image analysis model may be repeated for each interaction/step in the web browser task action that is received until an indication is received to stop recording of the action. The prototypes for each node and/or the neural network classification results may be stored in machine learning memory 322. The prototypes and/or neural network classification results may be adjusted based on training data that is received as telemetry data.

Once data from a recorded web browser action has been saved to machine learning memory 322 and a prototype has been built for each step/node in that action, perform action command 302 may be received. Perform action command 302 may be received via user interface element on a web browser, via a command to a digital assistant, and/or via an interaction with an operating system shell element. In this example, perform action command 302 is received in the context of webpage 304. Webpage 304 may be the same webpage as webpage 316. However, in some examples, webpage 316 may have been modified and the modified version of webpage 316 is webpage 304. In some examples, one or more node classifications may have been changed. In another examples, content may have been rearranged, modified, removed, and/or added to webpage 316, resulting in webpage 304. Thus, one advantage of applying a machine learning model to identify interacted-with web elements in a browser task action is that the model is capable of identifying those elements even if modifications have been made to the webpage and/or to the specific web element/node in question.

Computing environment 300 further includes web browser task action performance sub-environment 306. Web browser task action performance sub-environment 306 includes action identification engine 308, first node identification engine 310, and N node identification engine 312. Action identification engine 308 makes a determination that a perform action command has been received. For example, in the case where perform action command 302 is a natural language input from a digital assistant, action identification engine 308 comprises a natural language processing model that has been trained to identify “perform web browser task action” commands Alternatively, if perform action command 302 is an explicit command (e.g., a command to execute a web browser task action received via a user interface element), action identification engine 308 may not need to perform additional processing on the command prior to passing it to first node identification engine 310.

First node identification engine 310 performs one or more operations associated with identifying a node corresponding to a web element that was interacted with first during the recording of the web browser task action. In examples where the machine learning model that was applied during the recording process was an HTML node analysis model, first node identification engine 310 may look for a best node feature match for the interacted-with node from the recording and a corresponding best feature match on webpage 304. In some examples, more than one feature may be utilized to identify the node associated with the first step of the action that is being automatically performed. Once identified, the web element associated with the first node in the action may be populated utilizing information that was provided during the recording process (e.g., fill in a text entry field with the same information as was provided during recording, pick a same menu item from a menu selection element, pick a same date from a calendar/date selection element).

The same process described with regard to first node identification engine 310 may be performed for each subsequent node/step associated with an interacted-with node/web element during the recording of the web browser task action. Once the action is completed, action result 324 may be caused to be displayed. In some examples, if the action is completed as a background process (e.g., by the local device but not in a displayed web browser, by a server computing device but not in a displayed web browser), an indication of the result may be sent to a user account associated with the web browser. For example, if a restaurant reservation has been made via an executed web browser task action, a digital assistant may alert a user account (e.g., via email, via SMS message, via audio output) that the reservation has been made.

FIG. 4 illustrates a schematic diagram illustrating an example distributed computing environment 400 for training and applying an instance-based machine learning model for automating web browser task actions. In this example, an instance-based machine learning model is applied as a sequence labelling task. An instance-based model is relatively lightweight and can thus be applied entirely on the local device side. This is important for any data that a user may prefer to not provide to a cloud-based service, which may have higher processing capabilities and therefore be capable of performing heavier processing models. In this instance-based case, for each example (HTML node) to be classified, instead of seeking a generalized representation based on its context (text or HTML) and build models on top of that, the currently described model may store a set of features for the node as prototypes and build classification models by similarity comparison. The instance-based approach has the advantage of not encoding the unit of analysis (i.e., no need to load big embedding/dictionary at runtime) and instead only requires a measure of distance between different units. The distance measuring may be performed by distance matcher 408.

The illustrated approach defines an instance as a DOM node characterized by HTML features. The problem to be solved by the model differs from a traditional instance-based learning model setup in that each prediction is made not on a single instance (node), but a collection of instances coexisted in an HTML page. By taking advantage of the page structure (e.g., of webpage 402) and relying on a more robust confusion matrix (e.g., confusion matrix 416) to evaluate misclassified instances at each learning step, a Two-Stage IB4 (2SIB4) model that applies instance-based learning matching in two steps is utilized—first to extract a collection of nodes in an HTML page (e.g., utilizing extractor 404) corresponding to a region, then apply extraction inside a region to find the exact instances. The current model may also include a richer features space and more diverse distance metrics over traditional instance-based learning models. These modifications help reduce distance comparisons on correlated instances, enable extracting repeated patterns in a page (e.g., list entities), tolerate web-specific noises and accept incomplete page labels.

Within each stage, the model may classify a node as X or non-X (e.g., selected web-element, or non-selected web-element) based on its features. A node's features may include one or more of: surrounding name sequence (n nodes before and after), ID sequence, class sequence, text string, encoded text string (one of [number, alphabet, space, others] for each character text string). Another advantage of the instance-based approach is that it does not require a numerical representation of string/categorical features (e.g., embedding, one-hot), as long as it's possible to formulate the distance between different variations of the features. This allows the running of an inference on the client side without loading a large token dictionary.

The training process of the current model may comprise an iterative selection procedure that attempts to extract and synthesize the most useful set of “correct answers” based on labeled data. It solves the sequence labelling task by measuring the distance between unknowns and the “correct answers” and choosing the best set of “correct answers” to keep in memory at each step. The IB4 algorithm, compared to the IB1 or IB2 better addresses important concerns such as overfitting the noisy data and model size explosion. During the training, IB4 maintains a memory of all the knowledge (instances) learned so far, and at each step makes a prediction on a labeled web page to validate itself.

The model prioritizes significant good instances for prediction: newly added instances will need to go through a validation process before it is fully trusted. This helps to reduce the changes of storing noisy instances. The model discards significantly bad instances: low accuracy examples (e.g., wrongly labeled pages from vendors) may be discarded to minimize storage and misclassification. The discarding may be performed by forget gate 422. The model saves only misclassified instances to prevent storage explosion.

The saving of misclassified instances may be performed by remember gate 418. The model updates weights for different features that co-determine similarity between instances. The updating may be performed by update gate 420. This helps to learn the relevance of different features and regularizes the decision boundary.

As illustrated by computing environment 400, at predict time, the model takes the page DOM, URL, along with a few parameters as input and extracts all the entities. At training time, the model takes the page DOM, URL, labelled HTML nodes and a few parameters as input and automatically builds templates. The templates may be stored in instance-based learning memory 424.

Components of the model may include the following.

Classification function: the extraction design may comprise a two-step matching: first the bounding boxes then the actual entities, based on distance comparisons. The model may also utilize the PivotMatcher to reduce the number of similarity comparisons needed.

Distance metric: the model may utilize several similarity metrics to compare sequences of HTML nodes: hamming, levenshtein, and least common subsequence. The final distance score between a new instance and a prototype may be the weighted LP norm of all features.

Concept description updater: an IBLUpdater class that incrementally learn piecewise linear approximations of a concept with each example, based on the confusion matrix of the classification results, to mitigate the memory explosion problem and perform template selection.

Automatic region detection: bounding boxes of entities may be automatically learned during the labelling process by a least common ancestor algorithm so that users only need to label entity fields. This also allows the model to learn repeated patterns (e.g., list) in a page.

The following concepts/definitions relate to computing environment 400 and the above-described instance-based learning model.

Pattern: a set of extracted features that can distinguish an HTML node from the rest. A pattern has three components: (1) label—name used to identify the content within the current HTML node; (2) pivot—CSS selector of depth n leading to the current HTML node; (3) embedding—instance-based learning features as described above.

Template: a collection of patterns used to extract information from web pages. For example, an entity template may comprise a collection of patterns to identify an entity from web pages. To do so, it may contain two important types of patterns—(1) box patterns: patterns used to identify bounding blocks in the page corresponding to the entity [e.g., find boxes 410]; (2) field patterns: patterns used to identify attributes of the entity [e.g., find fields 412]. As another example, a site template may comprise a collection of entity templates for a given site (e.g., airline website, shopping website, etc.). This may be the main decision unit under the model. A site template is supposed to extract entities with high precision within the site.

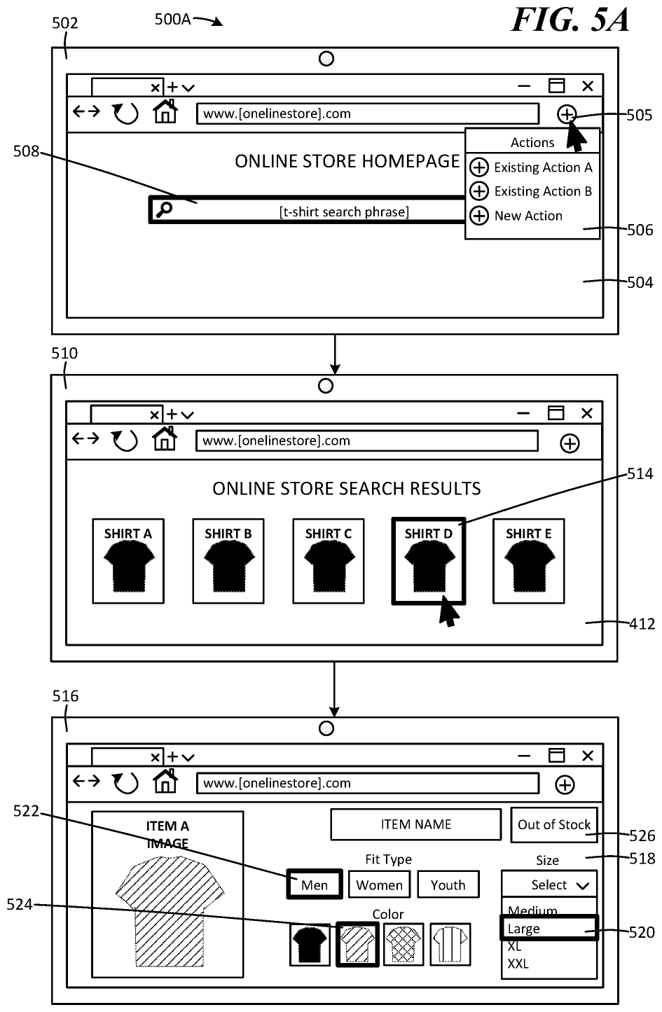

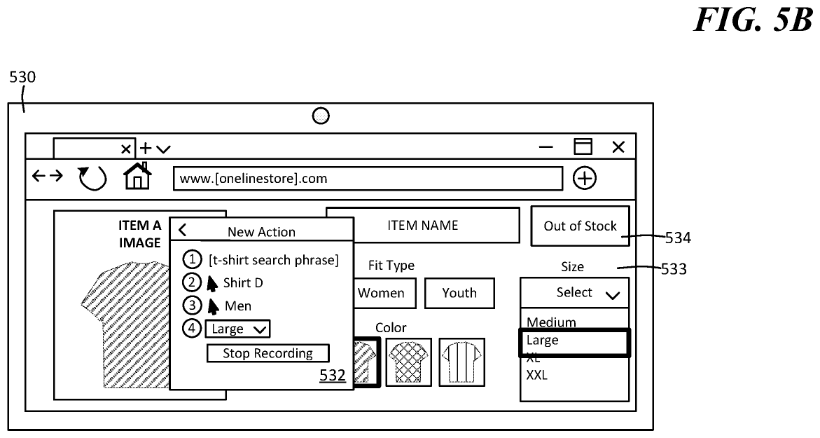

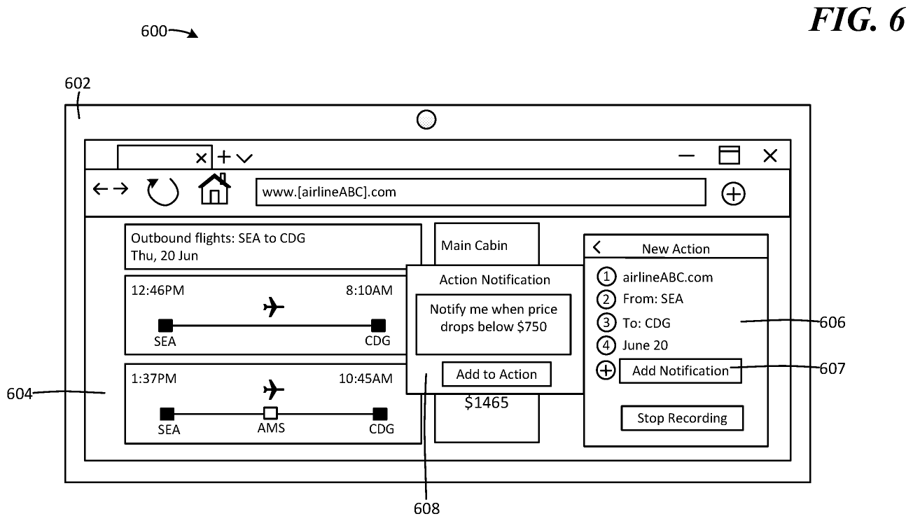

FIG. 5A illustrates a computing environment 500A for creating a new web browser task action across multiple pages of a website. Computing environment 500A includes computing device 502, computing device 510, and computing device 516. Each of those computing devices are the same computing device displaying the recording of different steps of a web browser task action.

Computing device 502 displays web browser 504. Web browser 504 is currently navigated to www.[onlinestore].com. Specifically, web browser 504 is navigated to and currently displaying the homepage for www.[onlinestore].com, which includes search input field 508 for searching the website for items. In this example, an interaction is detected with add new action element 505, which causes actions window 506 to be surfaced. Actions window 506 includes two existing action elements (“Existing Action A” and “Existing Action B”). Actions window 506 also includes a “New Action” element, which is interacted with, and thus the recording of a new web browser task action is initiated. Once the recording of the new web browser task action is initiated, an interaction with input field 508 is detected and “[t-shirt search phrase]” is entered in input field 508. In some examples, when the interaction with input field 508 is detected, the node associated with input field 508 may be tagged by the task action service. Additionally, when the search phrase is received in input field 508, that search phrase may be extracted and saved in association with the information associated with the node. In some examples, one or more nodes on the webpage may also be extracted and/or tagged and saved.

Once the search phrase has been entered in input field 508, a “perform search” indication may be received. This indication may be saved as a next step (or as part of the same step) as the input search phrase step of the new browser task action. Results are then displayed in web browser 412 on computing device 510. The search results include a plurality of t-shirts (Shirt A, Shirt B, Shirt C, Shirt D, Shirt E). An interaction with the web element corresponding to Shirt D is then received. The interaction in this instance is a mouse click. In some examples, when the interaction corresponding to the mouse click and Shirt D is detected, the node associated with that interaction may be tagged by the task action service. Additionally, when the interaction is detected, that interaction may be saved in association with the information associated with the node. In some examples, one or more nodes on the webpage may also be extracted and/or tagged and saved.

Once the interaction with the web element corresponding to Shirt D is made, an “element selection” indication may be received. This indication may be saved as a next step of the new browser task action. Results are then displayed in web browser 518 on computing device 516. That is, the new webpage includes information associated with Shirt D, including ordering information. In this example, a selection is made of “fit type” web element 522 (“Men”), “color” web element 524 (diagonal stripe), and “size” web element 520 (“Large”). Each of those interactions may be received by the task action service, corresponding nodes may be extracted/tagged, and additional nodes on the webpage may be extracted/tagged in association with those interactions. After selection of each of those web elements, “Out of Stock” element 526 is caused to be displayed, which indicates that the selected shirt is not currently in stock with the online store.

FIG. 5B illustrates the finalization of the new web browser task action created in FIG. 5A. Specifically, FIG. 5B illustrates a computing device 530, which is the same computing devices as computing device 502, 510, and 516. Computing device 530 displays web browser 533. Web browser 533 displays new action completion window 532, which displays a plurality of steps that were recorded during the recording of the new web browser task action as described in FIG. 5A. Specifically, new action completion window 532 displays: a first step action for selection of a search element and inputting “[t-shirt search phrase]”; a second step action for selecting the “Shirt D” element; a third element for selecting the “Men” fit option; and a fourth option for selecting the “Large” size option. New action completion window 532 also includes an option to stop recording the new web browser task action.

Browser 533 also displays out of stock element 534, indicating that the t-shirt that has been selected is out of stock. In some examples, an indication may be provided to the task action service to have the task action service automatically run the new action corresponding to the t-shirt search periodically and send an indication to a user if/when a determination is made that the out of stock element is converted to an “in stock” element. That is, a message or other communication may be sent to a user account associated with browser 533 when an automated task action search corresponding to the description of FIG. 5A and 5B returns an “in stock” value for the t-shirt at issue.

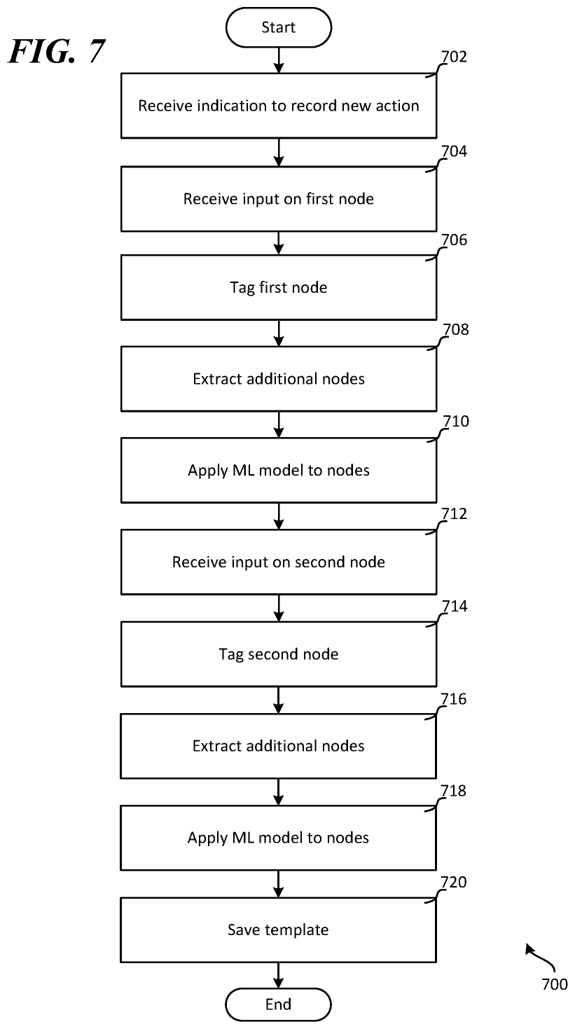

FIG. 6 illustrates a computing environment 600 for creating a new task action related to dynamic content and adding an option to be notified when the dynamic content meets a threshold value. Computing environment 600 includes computing device 602. Computing device 602 is connected to the Internet and is currently displaying browser 604, which is navigated to www.[airlineABC].com. A user is browsing flights from SEA (Seattle) to CDG (Paris) that leave on Thursday, June 20.

Browser 604 displays two different flights for the Seattle to Paris search. The currently displayed webpage corresponds to a search that was performed on a previous webpage and the currently displayed webpage provides the results of that search. The search results displayed on browser 604 include a first flight that leaves Seattle at 12:46 PM (with no layover) and arrives in Paris at 8:10 AM. The search results displayed on browser 604 also include a second flight that leaves Seattle at 1:37 PM (with a layover in Amsterdam) and arrives in Paris at 10:45 AM. The steps that were used to perform the flight search task action were recorded as part of a new browser task action. Those steps are shown in new action window 606. Specifically, those steps include: (1) navigate to www.[airlineABC].com (e.g., from a user's homepage or other webpage); (2) select “SEA” in a “from” field; (3) select “CDG” in a “to” field; and (4) select “June 20” in a “date” field.

The search result associated with the first flight (with no layover) has a price displayed for it (although not shown because it is covered by action notification 608) of S1443. The second flight (with a layover in Amsterdam) has a price displayed for it of S1465. A user may add a notification step to a web browser task action. Specifically, when a result of a web browser task action includes dynamic content (e.g., a price that changes, an item that goes in and out of stock as in FIG. 5B, availability that may change—such as restaurant reservations and concert tickets), the task action service may provide a selectable element for performing a task action periodically or at times based on certain rules or conditions, and sending a result to a user if/when a condition or threshold has been met.

In this example, new action window 606 includes add notification element 607, which has been selected. The selection of add notification element 607 causes action notification window 608 to be surfaced. Action notification window 608 includes a text field for a user to describe what type of notification the user would like. In this example, the user inputs “Notify me when price drops below $750”, and a selection of the “Add to Action” element on action notification window 608 may be utilized to provide that input to the task action service. The task action service may perform language processing on that input and add the desired notification to the new task action along with rules for performing the new task action autonomously. In other examples, rather than the user providing a natural language input to describe the type of action notification that they would like automatically performed, the task actions service may provide one or more selectable options (e.g., price, availability, etc.) that a user may select from. The task action service may also provide options for how often and/or at what intervals to perform the automated task action (e.g., daily, at 5 pm on Fridays, etc.).

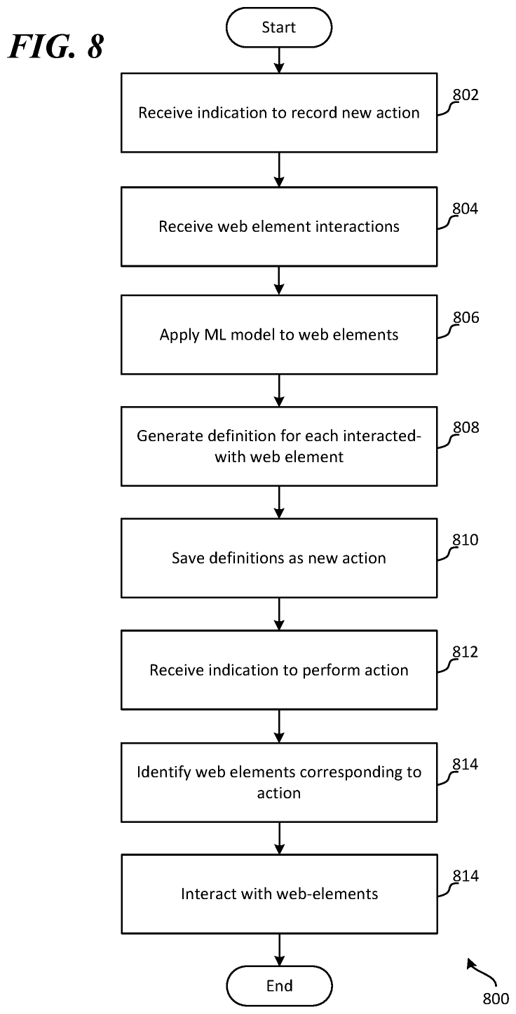

FIG. 7 is an exemplary method 700 for automating web browser task actions. The method 700 begins at a start operation and flow continues to operation 702.

At operation 702 an indication to record a new browser task action comprising a plurality of steps is received. The indication may be received by a task action service. In some examples, the task action service may be located all or in part on a local device. For example, the task action service may be incorporated as part of a browser application executed locally on a local computing device. In other examples, the task action service may be located all or in part in the cloud. For example, the task action service may be incorporated in a remote browser service or a remote stand-alone service. The indication to record a new web browser task action may be received via an explicit command received via a web browser application. In other examples, the indication to record a new web browser task action may be received via an explicit command received via a operating system shell element. In still other examples, the indication to record a new web browser task action may be received via a natural language input (e.g., a voice command to a digital assistant, a text command to a digital assistant).

From operation 702 flow continues to operation 704 where an input on a first node on a first webpage is received. The first node corresponds to a webpage input element. For example, the first node may be a text entry field, a button, and/or a menu. The first node corresponds to a step in a web browser task action.

From operation 704 flow continues to operation 706 where the first node is tagged. In some examples, the HTML corresponding to the webpage where the first node is located may be extracted and the first node may be tagged in the extracted HTML.

From operation 706 flow continues to operation 708 where a first plurality of additional nodes on the first webpage are extracted. In some examples, the first plurality of additional nodes may comprise one or more nodes above the first node in the HTML for the webpage and/or one or more nodes below the first node in the HTML for the webpage. In other examples, the first plurality of additional nodes may comprise nodes that are not consecutively ordered above or below the first node.

From operation 708 flow continues to operation 710 where a machine learning model is applied to the first plurality of additional nodes, wherein the machine learning model has been trained to define interacted-with nodes from a webpage based on one or more features of additional nodes on the webpage. According to some examples, the machine learning model may comprise an instance-based learning model. In other examples, the machine learning model may comprise an embedding model associated with a corpus. In still other examples, the machine learning model may comprise an image-based neural network.

From operation 710 flow continues to operation 712 where an input is received on a second node. The second node corresponds to a webpage input element. For example, the second node may be a text entry field, a button, and/or a menu. The second node corresponds to a step in a web browser task action.

From operation 712 flow continues to operation 714 where the second node is tagged. In some examples, the HTML corresponding to the webpage where the second node is located may be extracted and the second node may be tagged in the extracted HTML. The webpage that is extracted may or may not be the same webpage as the webpage where the first node was located and extracted from. For example, if the first node corresponded to a button, selection of that button may have directed the web browser to a second webpage and the second node may be located on the second webpage.

From operation 714 flow continues to operation 716 where a second plurality of additional nodes from a same webpage as a webpage that the second node resides on is extracted. The second plurality of additional nodes may comprise one or more nodes above the second node in the HTML for the webpage and/or one or more nodes below the second node in the HTML for the webpage. In other examples, the second plurality of additional nodes may comprise nodes that are not consecutively ordered above or below the second node.

From operation 716 flow continues to operation 718 where the machine learning model is applied to the second node and the second plurality of additional nodes.

From operation 718 flow continues to operation 720 where a template comprising a first definition for the first node and a second definition for the second node are saved. The template may be utilized to identify the first and second nodes when the web browser task action is run.

From operation 720 flow continues to an end operation and the method 700 ends.

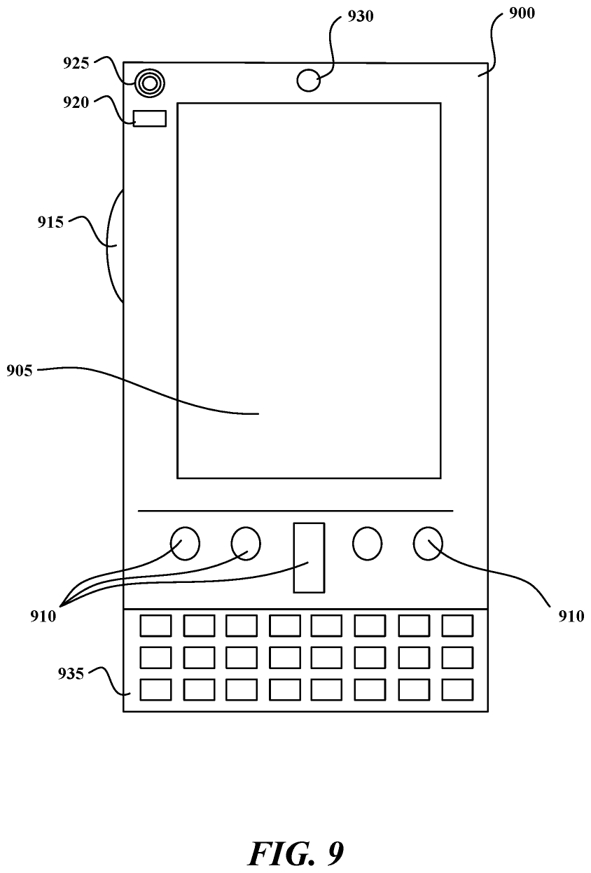

FIG. 8 is another exemplary method 800 for automating web browser task actions. The method 800 begins at a start operation and flow moves to operation 802.

At operation 802 an indication to record a new browser task action is received.

From operation 802 flow continues to operation 804 where a plurality of web element interactions on a website are received, each of the plurality of web element interactions associated with a different web element.

From operation 804 flow continues to operation 806 where a machine learning model is applied to each interacted-with web element, wherein the machine learning model has been trained to generate a definition for web elements. The indication may be received by a task action service. In some examples, the task action service may be located all or in part on a local device. For example, the task action service may be incorporated as part of a browser application executed locally on a local computing device. In other examples, the task action service may be located all or in part in the cloud. For example, the task action service may be incorporated in a remote browser service or a remote stand-alone service. The indication to record a new web browser task action may be received via an explicit command received via a web browser application. In other examples, the indication to record a new web browser task action may be received via an explicit command received via an operating system shell element. In still other examples, the indication to record a new web browser task action may be received via a natural language input (e.g., a voice command to a digital assistant, a text command to a digital assistant).

From operation 806 flow continues to operation 808 where a definition for each interacted-with web element is generated. A definition for an interacted-with web element may comprise one or more features associated with a node corresponding to the interacted-with web element and one or more features associated with one or more nodes from the HTML on the same webpage as the node corresponding to the interacted-with web element. The one or more features may include one or more of: surrounding name sequence (n nodes before and after), ID sequence, class sequence, text string, encoded text string (one of [number, alphabet, space, others] for each character text string).

From operation 808 flow continues to operation 810 where the definitions for each interacted-with web element are saved as part of the new browser task action. The definitions for each interacted-with web element may be saved as templates in a templates database.

From operation 810 flow continues to operation 812 where an indication to perform the new browser task action is received. The indication may be received via an explicit command in a web browser, via a natural language input, via a natural language input to a digital assistant, and/or via operating system shell element, for example.

From operation 812 flow continues to operation 814 where each of the interacted-with web elements are identified utilizing the definitions for each interacted-with web element. That is, a match analysis for a web element on a webpage and a definition is performed for each step of the web browser task action, and a best matching web element corresponding to the definition for the web element at each step is identified as the correct element for that step.

From operation 814 flow continues to operation 816 where each of the interacted-with web elements are automatically interacted with. The interaction may include inputting text in a text field of a web element, “clicking” of a button, and/or selecting an item from a menu, for example. That is, the selections and input that were received during recording of the task action are input at operation 816 for each corresponding step.

From operation 816 flow moves to an end operation and the method 800 ends.

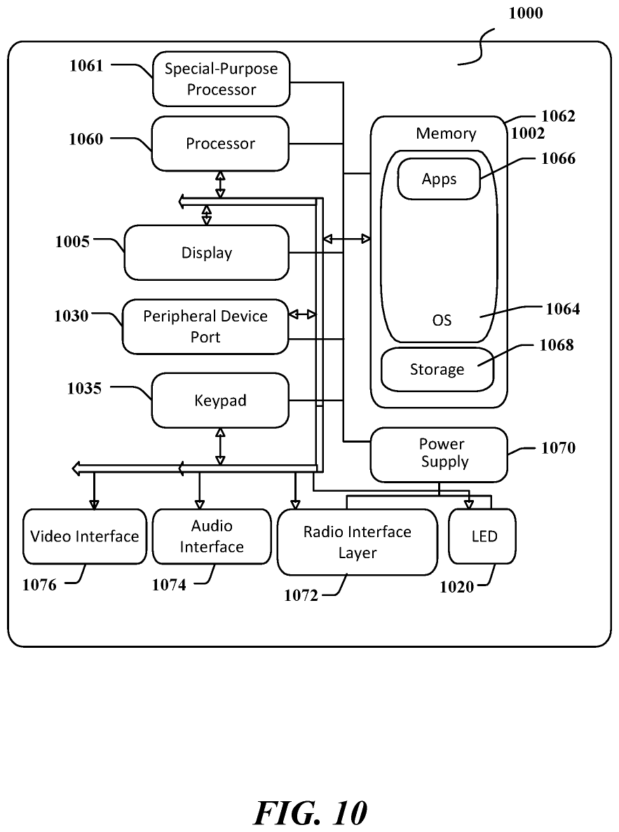

FIGS. 9 and 10 illustrate a mobile computing device 900, for example, a mobile telephone, a smart phone, wearable computer (such as smart eyeglasses), a tablet computer, an e-reader, a laptop computer, or other AR compatible computing device, with which embodiments of the disclosure may be practiced. With reference to FIG. 9, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative aspects, mobile computing device 900 may incorporate more or fewer input elements. For example, the display 905 may not be a touch screen in some embodiments. In yet another alternative embodiment, the mobile computing device 900 is a portable phone system, such as a cellular phone. The mobile computing device 900 may also include an optional keypad 935. Optional keypad 935 may be a physical keypad or a “soft” keypad generated on the touch screen display. In various embodiments, the output elements include the display 905 for showing a graphical user interface (GUI), a visual indicator 920 (e.g., a light emitting diode), and/or an audio transducer 925 (e.g., a speaker). In some aspects, the mobile computing device 900 incorporates a vibration transducer for providing the user with tactile feedback. In yet another aspect, the mobile computing device 900 incorporates input and/or output ports, such as an audio input (e.g., a microphone jack), an audio output (e.g., a headphone jack), and a video output (e.g., a HDMI port) for sending signals to or receiving signals from an external device.

FIG. 10 is a block diagram illustrating the architecture of one aspect of a mobile computing device. That is, the mobile computing device 1000 can incorporate a system (e.g., an architecture) 1002 to implement some aspects. In one embodiment, the system 1002 is implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000, including instructions for providing and operating a web browser task action platform.

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 920 may be used to provide visual notifications, and/or an audio interface 1074 may be used for producing audible notifications via the audio transducer 925. In the illustrated embodiment, the visual indicator 920 is a light emitting diode (LED) and the audio transducer 925 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 925, the audio interface 1074 may also be coupled to a microphone to receive audible input, such as to facilitate a telephone conversation. In accordance with embodiments of the present disclosure, the microphone may also serve as an audio sensor to facilitate control of notifications, as will be described below. The system 1002 may further include a video interface 1076 that enables an operation of an on-board camera 930 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10 by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio interface layer 1072 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

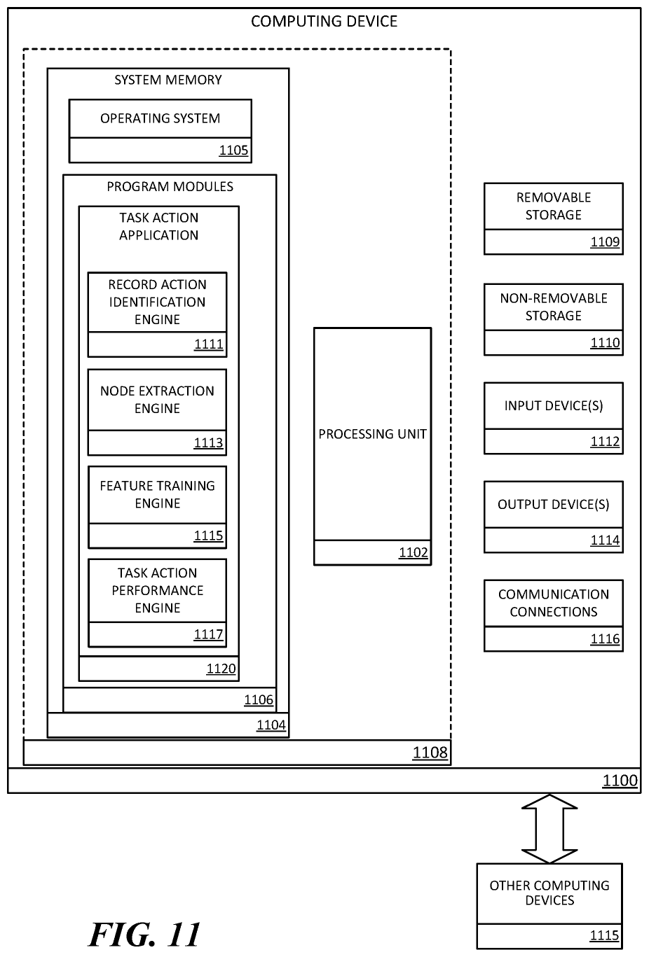

FIG. 11 is a block diagram illustrating physical components (e.g., hardware) of a computing device 1100 with which aspects of the disclosure may be practiced. The computing device components described below may have computer executable instructions for assisting with task action recording and performance In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 suitable for running one or more task action applications and/or services. The operating system 1105, for example, may be suitable for controlling the operation of the computing device 1100. Furthermore, embodiments of the disclosure may be practiced in conjunction with a graphics library, other operating systems, or any other application program and is not limited to any particular application or system. This basic configuration is illustrated in FIG. 11 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 11 by a removable storage device 1109 and a non-removable storage device 1110.

As stated above, a number of program modules and data files may be stored in the system memory 1104. While executing on the processing unit 1102, the program modules 1106 (e.g., task action application 1120) may perform processes including, but not limited to, the aspects, as described herein. According to examples, record action identification engine 1111 may perform one or more operations associated with identifying a “record action” command The command may be explicit (e.g., received via a web browser application element). In other examples, the command may be received via natural language that is processed utilizing a natural language processing engine. Node extraction engine 1113 may perform one or more operations associated with extracting a primary node and one or more secondary nodes associated with an interacted-with web element during the recording process of a web browser task action. Feature training engine 1115 may perform one or more operations associated with identifying best features between a primary node and one or more secondary nodes for creating a definition/template for an interacted-with web element. Task action performance engine 1117 may perform one or more operations associated with matching a definition/template for an interacted-with web element to a web element on a webpage. Task action performance engine 1117 may perform these operations for each step of a web browser task action.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1100 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1100 may also have one or more input device(s) 1112 such as a keyboard, a mouse, a pen, a sound or voice input device, a touch or swipe input device, etc. The output device(s) 1114 such as a display, speakers, a printer, etc. may also be included. The aforementioned devices are examples and others may be used. The computing device 1100 may include one or more communication connections 1116 allowing communications with other computing devices 1150. Examples of suitable communication connections 1116 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

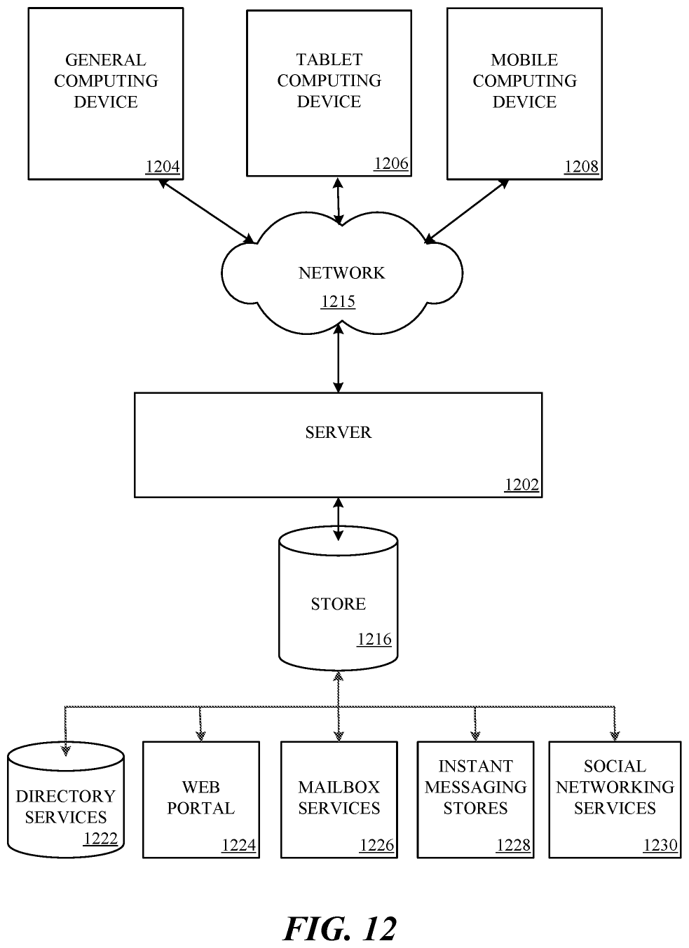

FIG. 12 illustrates one aspect of the architecture of a system for processing data received at a computing system from a remote source, such as a personal/general computer 1204, tablet computing device 1206, or mobile computing device 1208, as described above. Content displayed at server device 1202 may be stored in different communication channels or other storage types. For example, various documents may be stored using a directory service 1222, a web portal 1224, a mailbox service 1226, an instant messaging store 1228, or a social networking site 1230. The program modules 1106 may be employed by a client that communicates with server device 1202, and/or the program modules 1106 may be employed by server device 1202. The server device 1202 may provide data to and from a client computing device such as a personal/general computer 1204, a tablet computing device 1206 and/or a mobile computing device 1208 (e.g., a smart phone) through a network 1215. By way of example, the computer systems described herein may be embodied in a personal/general computer 1204, a tablet computing device 1206 and/or a mobile computing device 1208 (e.g., a smart phone). Any of these embodiments of the computing devices may obtain content from the store 1216, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer-implemented method for automating web browser task actions, the method comprising:
receiving an indication to record a new browser task action comprising a plurality of steps;
receiving an input on a first node on a first webpage;
tagging the first node;
extracting a first plurality of additional nodes on the first webpage;
applying a machine learning model to the first node and the first plurality of additional nodes, wherein the machine learning model has been trained to define interacted-with nodes from a webpage based on one or more features of additional nodes on the webpage;
receiving an input on a second node;
tagging the second node;
extracting a second plurality of additional nodes from a same webpage as a webpage that the second node resides on;
applying the machine learning model to the second node and the second plurality of additional nodes; and
saving a template comprising a first definition for the first node and a second definition for the second node.

2. The computer-implemented method of claim 1, further comprising:
receiving an indication to perform the new browser task action
identifying, utilizing the template, the first and second nodes; and
automatically interacting with the first and second nodes to perform the new browser task action.

3. The computer-implemented method of claim 2, wherein:
the input on the first node comprises a text input; and
automatically interacting with the first node comprises inserting the text input in the first node.

4. The computer-implemented method of claim 2, wherein:
the input on the first node comprises a selection of a menu item; and
automatically interacting with the first node comprises selecting the menu item.

5. The computer-implemented method of claim 1, wherein the machine learning model is an instance-based learning model.

6. The computer-implemented method of claim 5, wherein the one or more features of the first plurality additional nodes that the machine learning model uses to define the first node comprise at least one of: a surrounding name sequence; an ID sequence; a class sequence; a text string; and an encoded text string for each character in a text string.

7. The computer-implemented method of claim 1, wherein the second node is interacted with and tagged on a different webpage than the first webpage.

8. The computer-implemented method of claim 1, wherein the second node is interacted with and tagged on the first webpage.

9. The computer-implemented method of claim 1, further comprising:
receiving an indication to edit the new browser task action;
receiving an indication to make interaction with the second node in the new browser task action a manual interaction; and
converting the interaction with the second node in the new browser task action as a manual interaction.

10. A system for automating web browser task actions, comprising:
a memory for storing executable program code; and
one or more processors, functionally coupled to the memory, the one or more processors being responsive to computer-executable instructions contained in the program code and operative to:
receive an indication to record a new browser task action;
receive a plurality of web element interactions on a website, each of the plurality of web element interactions associated with a different web element;
apply a machine learning model to each interacted-with web element, wherein the machine learning model has been trained to generate a definition for web elements;
generate a definition for each interacted-with web element;
save the definitions for each interacted-with web element as part of the new browser task action;
receive an indication to perform the new browser task action;
identify, utilizing the definitions for each interacted-with web element, each of the interacted-with web elements; and
automatically interact with each of the interacted-with web elements.

11. The system of claim 10, wherein the one or more processors are further responsive to the computer-executable instructions contained in the program code and operative to:
receive an indication to make interaction with one of the interacted-with web elements a manual input during execution of the new browser task action; and
convert the interacted-with web element in the new browser task action to a manual input.

12. The system of claim 11, wherein the converted interacted-with web element is a text input web element.

13. The system of claim 11, wherein the converted interacted-with web element is a menu selection web element.

14. The system of claim 10, wherein the machine learning model comprises a neural network, and the definitions for each interacted-with web element comprise values determined from input of each of the interacted-with web elements to the neural network.

15. The system of claim 10, wherein the machine learning model comprises an instance-based learning model, and the definitions for each interacted-with web element comprise values determined from input of each of the interacted-with web elements and input of each of a plurality of other web elements located on the website to the instance-based learning model.

16. The system of claim 10, wherein the one or more processors are further responsive to the computer-executable instructions contained in the program code and operative to:
receive an indication to periodically execute the new browser task action;
determine whether a specific value results from execution of the new browser task action; and
send a notification to a user account associated with the new browser task action if the specific value results from execution of the new browser task action.

17. The system of claim 10, wherein the one or more processors are further responsive to the computer-executable instructions contained in the program code and operative to:
receive an indication to periodically execute the new browser task action;
determine whether a value for a specific web element that results from execution of the new browser task action meets a threshold value; and
send a notification to a user account associated with the new browser task action if the value for the specific web element meets the threshold value.

18. A computer-readable storage device comprising executable instructions that, when executed by one or more processors, assists with automating web browser task actions, the computer-readable storage device including instructions executable by the one or more processors for:
receiving an indication to record a new browser task action comprising a plurality of steps;
receiving an input on a first node on a first webpage;
tagging the first node;
extracting a first plurality of additional nodes on the first webpage;
applying a machine learning model to the first node and the first plurality of additional nodes, wherein the machine learning model has been trained to define interacted-with nodes from a webpage based on one or more features of additional nodes on the webpage;
receiving an input on a second node;
tagging the second node;
extracting a second plurality of additional nodes from a same webpage as a webpage that the second node resides on;
applying the machine learning model to the second node and the second plurality of additional nodes; and
saving a template comprising a first definition for the first node and a second definition for the second node.

19. The computer-readable storage device of claim 18 wherein the instructions are further executable by the one or more processors for:
receiving an indication to perform the new browser task action;
identifying, utilizing the template, the first and second nodes; and
automatically interacting with the first and second nodes to perform the new browser task action.

20. The computer-readable storage device of claim 18, wherein the instructions are further executable by the one or more processors for:
receiving an indication to edit the new browser task action;
receiving an indication to make interaction with the second node in the new browser task action a manual interaction; and
converting the interaction with the second node in the new browser task action as a manual interaction.
